(19) United States
(12) Patent Application Publication
(10) Pub. No.: US 2004/0150637 A1
(43) Pub. Date: Aug. 5, 2004

(54) Method and apparatus for displaying markup document linked to applet

(75) Inventors: Hyun-kwon Chung, Seoul (KR); Jung-kwon Heo, Seoul (KR); Sung-wook Park, Seoul (KR); Kil-soo Jung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/716,868

(22) Filed: Nov. 20, 2003

(30) Foreign Application Priority Data
Dec. 12, 2002 (KR) 2002-79185

(51) Int. Cl. G06T 1/00

(52) U.S. Cl. 345/418

(57) ABSTRACT

A method and an apparatus displaying a markup document linked to an applet by delaying display of image output information for the markup document and synchronously displaying the delayed image output information for the markup document and an applet output when rendering of the applet is completed. The markup document linked to an applet is displayed by synchronizing the applet and the markup document outputs so that an initial blank applet image is not displayed while initializing and executing the applet. Accordingly, a user conveniently views a markup image linked to an applet.

### CROSS-REFERENCE TO RELATED APPLICATIONS

This application claims the priority of Korean Patent Application No. 2002-79185, filed on Dec. 12, 2002 in the Korean Intellectual Property Office, which is incorporated herein in its entirety by reference.

### BACKGROUND OF THE INVENTION

1. Field of the Invention

The present invention relates to displaying a markup document by a computer, and more particularly, to a method and an apparatus for displaying a markup document including an applet.

2. Description of the Related Art

Markup documents linked to Java applets are produced to conveniently interact with users or construct animated web pages. Markup documents, which are formed using markup languages, such as HTML and XML, present markup binary content resources, such as text, images, and graphics, and serve as applications that are executed using analysis engines, which interpret the markup languages.

FIG. 5 is an example initial image displayed by a computer, which conventionally displays a markup document linked to a Java applet. Referring to FIG. 5, when a user calls and executes a markup document with a linked Java applet, an image forming the outline of the markup document is displayed first, and the linked Java applet is displayed later. This is because a specific amount of time is required to display an initial image of the Java applet by initializing and executing the Java applet. Thus, the user must watch a markup image having a blank applet region, which displays nothing, and a message informing the user that a corresponding class for executing the Java applet is loading, or a message informing the user of executing initialization, until the initial image of the Java applet is displayed.

### SUMMARY OF THE INVENTION

The present invention provides a method and a system for displaying a markup document linked to applets, by which the applets and the markup document are simultaneously displayed when displaying the markup document linked to the applets.

Additional aspects and/or advantages of the invention will be set forth in part in the description which follows and, in part, will be obvious from the description, or may be learned by practice of the invention.

The present invention may be achieved by a method of displaying a markup document linked to an applet, the method comprising delaying display of image output information for the markup document; and synchronously displaying the delayed image output information and an applet output when the rendering of the applet is completed.

According to an aspect of the invention, the delaying of the display of the image output information may comprise buffering the image output information for the markup document.

According to an aspect of the invention, synchronously displaying the delayed image output information and the applet output for an initial image of the applet may comprise simultaneously providing the delayed image output information and the applet output for the initial image of the applet to a display device based on an output control signal.

According to an aspect of the invention, the applet may be formed of program codes having an output method different from that of the markup document.

According to an aspect of the invention, the output control signal may be provided from an applet executing engine, which interprets the applet, or a presentation engine, which interprets the markup document.

According to an aspect of the invention, the delaying of the display of the image output information may comprise text output as the image output information and at least one of image output and audio output.

The present invention may also be achieved by an information storage medium controlling a computer, the information storage medium comprising a markup document; and an applet linked to the markup document, wherein the applet or the markup document includes image output delay information used to delay display of the markup document.

According to an aspect of the invention, the applet may include a delay function as the image output delay information for synchronizing image output information of the markup document with output information of the applet.

According to an aspect of the invention, the applet may execute in any one state of an initial state, a start state, a stop state, and a destroy state.

According to an aspect of the invention, the applet may comprise a delay function as the image output delay information delaying display of image output information for the markup document; and a delay cancel function canceling the delay of the display of the markup document when a rendering of an initial image of the applet is completed by initializing and executing the applet.

According to an aspect of the invention, the markup document may comprise tag or attribute indication information, which must be synchronously displayed with the output information of the applet.

The present invention may also be achieved by a computer system comprising a presentation engine, which interprets a markup document; and an applet executing engine, which interprets an applet linked to the markup document, wherein the presentation engine delays displaying image output information for the markup document, and synchronizes and outputs the delayed image output information and an applet output to a display device of the computer, when an output control signal, which informs a user of completion of rendering of the applet output, is input from the applet executing engine.

According to an aspect of the invention, the presentation engine may comprise a buffer, which performs buffering to delay the display of the image output information for the markup document.

According to an aspect of the invention, the presentation engine may comprise an audio buffer, which buffers audio output, and a video buffer, which buffers video output, to delay the display of the image output information for the markup document.

### BRIEF DESCRIPTION OF THE DRAWINGS

The above and/or other aspects and advantages of the present invention will become apparent and more readily appreciated from the following description of the embodiments, taken in conjunction with the attached drawings in which:

FIG. 1 is a functional block diagram of a computer system, according to an embodiment of the present invention;

FIG. 2 is a functional block diagram of a presentation engine interpreting a markup document, according to an embodiment of the present invention;

FIG. 3 is a block diagram of a decoder displaying a markup document including an applet, according to an embodiment of the present invention;

FIG. 4 is a state diagram of executing an applet linked in a markup document, according to an embodiment of the present invention;

FIG. 5 is an example of a displayed initial markup image linked to an applet, according to a conventional method of displaying a markup document linked to an applet; and

FIG. 6 is an example of a displayed initial markup image linked to an applet, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

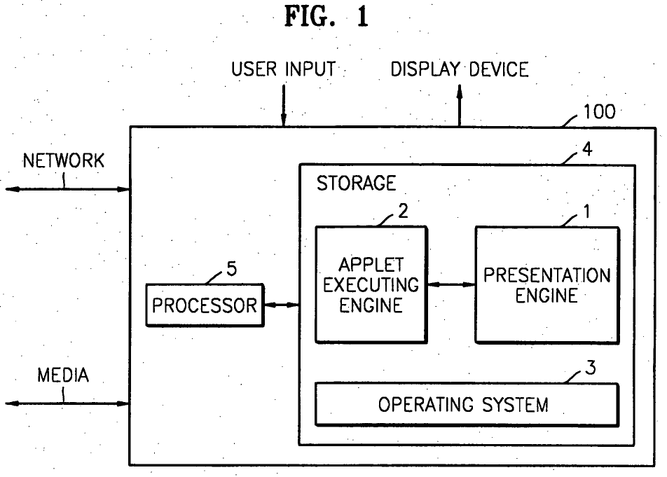

FIG. 1 is a functional block diagram of a computer system 100, according to an embodiment of the present invention. Referring to FIG. 1, the system 100 accessible to a network, for example, the Internet, and to media, for example, optical disks and magnetic disks, includes a processor 5 and a storage 4.

An executing (operating) system 3 is installed in the storage 4. Further, a presentation engine 1 and an applet executing engine 2 interfacing with each other via the operating system 3 are installed in the storage 4. Here, the operating system 3, the presentation engine 1, and the applet executing engine 2 are called and executed by the processor 5. According to the present invention, to display a markup document linked to an applet, the presentation engine 1, which interprets the markup document linked to the applet, controls rendering and output of the linked applet or the markup document to a display device (not shown) in order to synchronously display the applet and the markup document. Typically, the markup document is written according to Extensible Hypertext Markup Language (XHTML). The applet executing engine 2, which interprets the applet linked to the markup document, analyzes the Java applet and provides an output control signal to the presentation engine 1. Here, the Java applet is a small-sized application that is constructed using the Java programming language and uses program codes that have an output method different from the output of the markup document.

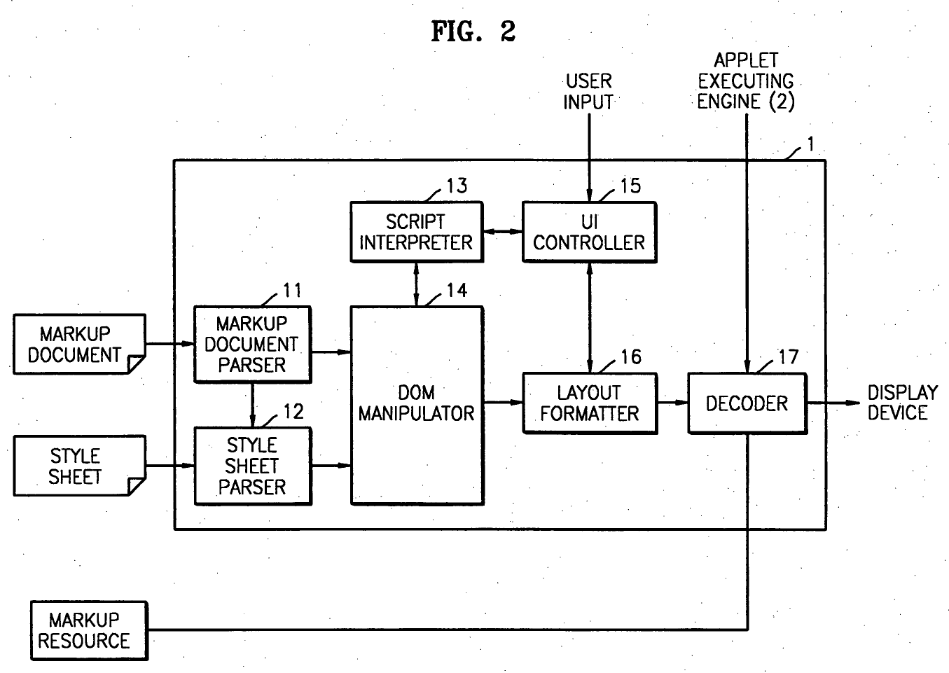

FIG. 2 is a functional block diagram of the presentation engine 1, according to an embodiment of the present invention. Referring to FIG. 2, the presentation engine 1 includes a markup document parser 11, a style sheet parser 12, a script interpreter 13, a document object model (DOM) manipulator 14, a user interface (UI) controller 15, a layout formatter 16, and a decoder 17.

Typically, the markup document parser 11 parses an XHTML document, which is formed using the XHTML language, and transfers information for generating a document tree to the DOM manipulator 14. The style sheet parser 12 interprets a style sheet and transfers information for generating a style rule/selector list to the DOM manipulator 14. Here, the style sheet allows the markup documents to have various formats. According to an aspect of the present invention, the grammar and the format of the style sheet are formed according to a cascading style sheet (CSS) of W3C.

The script interpreter 13 interprets the script codes included in the markup document and transfers the analysis result to the DOM manipulator 14. The DOM manipulator 14 allows forming the markup document into a program object or correcting the markup document. In other words, the DOM manipulator 14 corrects or supplements the document tree and the style rule/selector list, by interfacing with the script interpreter 13. In addition, the DOM manipulator 14 reanalyzes the document tree information input from the markup document parser 11 to find script codes connected to the document tree, to be executed, and informs the script interpreter 13 of the script codes. The scrip interpreter 13 interprets and executes the script codes. Furthermore, the DOM manipulator 14 reads the markup binary content resources, such as images and audio files, linked to the markup document into a memory (not shown) of the presentation engine 1. The DOM manipulator 14 also loads the applet linked to the markup document into a memory (not shown) of the applet executing engine 2, and the applet executing engine 2 calls and executes an initialization function init( ), which initializes the applet.

The layout formatter 16 applies the style rule/selector list generated by the DOM manipulator 14 to the document tree generated by the DOM manipulator 14 and generates a corresponding formatting structure according to the format of the documents that are output based on the document tree. Here, examples of the format of the documents include pages to be displayed on a computer screen, pages to be displayed on a TV screen, and output sound. The formatting structure seems to have a structure similar to that of the document tree; however, the formatting structure may utilize a pseudo-element and not require a tree structure. In other words, the formatting structure is dependent on implementation. In addition, the formatting structure may have a larger or less amount of information than the document tree. For example, when the element of the document tree has “none” as a display attribute value, the element does not generate a value for the formatting structure. According to an aspect of the present invention, the formatting structure is formed according to the CSS 2 processing model. More particularly, the description of the formatting structure is disclosed in the CSS 2 processing model. The layout formatter 16 transfers the formatting structure to the decoder 17, which renders the markup document according to the format of the output document, i.e., a target display and sound format.

The decoder 17 decodes the markup binary content resources, for example, images, graphics, and audio for displaying the markup document, and renders the markup binary content resources to display the markup binary content resources on selected locations of a screen, according to the formatting structure input from the layout formatter. In addition, the decoder 17 receives the applet output for the initial image of the applet from the applet executing engine 2 and renders the applet output to display the applet on selected locations of the screen according to the formatting structure input from the layout formatter. According to an aspect of the invention, the order of the rendering of the markup binary content resources and the rendering of the applet output can be exchanged (controlled) by the applet executing engine 2 and/or the presentation engine 1, to simultaneously display (including any audio output) the markup document image and the applet image as the markup image. For example, if a large amount of time is required to render the markup binary content resources due to a large number of markup binary content resources, the decoder 17 is controlled to render the markup binary content resources before rendering the applet output.

Typically, the applet executing engine 2 interprets the applet, which is linked to the markup document and includes image output delay information, and outputs an output control signal to the decoder 17. Thus, the decoder 17 reserves the rendering of the markup document for displaying the markup document and renders the applet first (e.g., typically an initial image of the applet), or renders the markup document and waits for the completion of the rendering of the applet, to synchronously display the markup document and the initial image of the applet on a display device. Accordingly, the markup image obtained from the markup document and the initial image of the applet are simultaneously displayed.

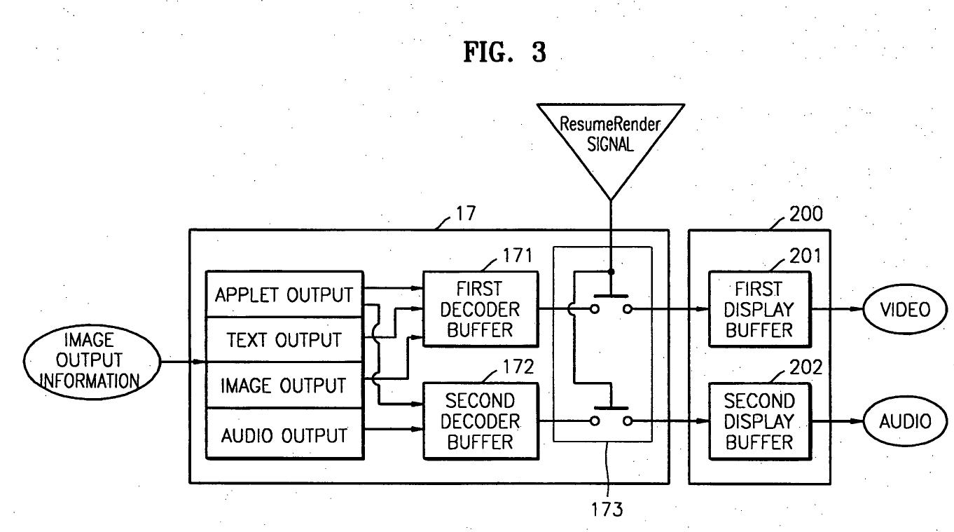

FIG. 3 is a block diagram of the decoder 17 displaying a markup document including an applet on a display device 200 for explaining a display method according to an embodiment of the present invention. Referring to FIG. 3, the decoder 17 includes two buffers, i.e., a first decoder buffer 171 and a second decoder buffer 172. Here, the first decoder buffer 171 buffers video data, and the second decoder buffer 172 buffers audio data.

The decoder 17 receives the markup image output information, which includes the markup document output and the applet output, from the layout formatter 16. In particular, the decoder 17 decodes the markup binary content resources to be decoded as the markup document output. Therefore, the markup image output information is formed of, for example, text, image, and audio from the markup document output, and text, image, and audio from the applet output linked to the markup document. Typically, the applet output provided from the applet executing engine 2 includes at least one of image output and audio output. The image output and text output of the markup document, and the image output and text output of the applet output are input to and buffered in the first decoder (e.g., video) buffer 171. The audio output of the applet output and the audio output of the markup document output are input to and buffered in the second decoder (i.e., audio) buffer 172.

The applet executing engine 2 interprets and executes the applet and transfers an output control signal, according to the image output delay information included in the applet, to the decoder 17. The decoder 17 does not input decoded markup image output information to a display device 200 and buffers the markup image output information in the decoder buffers, i.e., the first decoder buffer 171 and the second decoder buffer 172, until the initial image of the applet is rendered and stored in the decoder buffers 171 and 172. Thereafter, the decoder 17 controls switches 173 to input the applet output and the markup document image output information (i.e., collectively referred to as the markup image output information) to the display device 200 at the same time in response to the output control signal from the applet executing engine 2. In other words, for example, according to an aspect of the invention, the applet executing engine 2 initializes and executes the Java applet to transfer a ResumeRender signal to the decoder 17 when the Java applet is in a state of being possibly displayed (i.e., some applet output is in a state of being ready to be displayed). Thus, the buffers of the decoder 17 connect to the buffers of the display device 200. In other words, the first decoder buffer 171 and the second decoder buffer 172 connect to a first display buffer 201 and a second display buffer 202, respectively.

More particularly, initially the applet executing engine 2 generates a SuspendRender signal as the output control signal to the decoder 17 by calling a function SuspendRender( ), which is included in the Java applet, or the presentation engine 1 generates the SuspendRender signal as the output control signal to the decoder 17, according to a tag or attribute, which is included in the markup document, to suspend output of the markup image. When the SuspendRender signal is generated, the markup image output information is not input to the display device 200, but buffered in the buffers of the decoder 17. Thereafter, the applet executing engine 2 generates the ResumeRender signal after completing the rendering of the applet by calling a function Paint( ) of the applet to execute the Java applet and to display the applet initial image which includes inputting the applet output to the first and second decoder buffers 171 and 172. Thus, the first decoder buffer 171 and the second decoder buffer 172 connect to the first display buffer 201 and the second display buffer 202, respectively. When the buffers are connected, the delayed markup image and the initial image of the applet are simultaneously output to the display device 200 and displayed. According to an aspect of the invention, the ResumeRender signal can be generated by the presentation engine 1 instead of the applet executing engine 2.

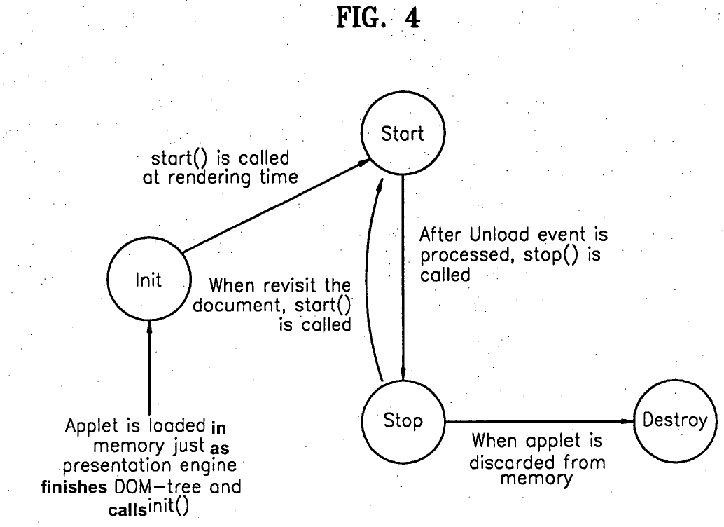

FIG. 4 is a state diagram of executing an applet linked in a markup document, according to an embodiment of the present invention. Referring to FIG. 4, when the presentation engine 1 generates a DOM tree, the applet is loaded into the memory (not shown) of the applet executing engine 2, and the applet executing engine 2 calls init( ) to initialize the applet. Accordingly, the applet enters initialization state. Thereafter, the applet executing engine 2 calls a function start( ) to start the applet. Accordingly, the applet becomes in a start state for starting the execution of the applet. In this state, the image of the applet is displayed and it is determined, depending on output rendering states of the markup document and/or the applet, whether SuspendRender or ResumeRender signals should be generated to the decoder 17 to control the markup image output for simultaneously outputting the markup document image and the linked applet image to the display device 200. According to an aspect of the invention, the markup image output delay information is determined (set) according to an amount of output rendering time of the markup document and/or the applet. If an unload event is processed while displaying the applet image and interacting with the user, the applet executing engine 2 calls a function stop( ). Here, the unload event denotes, for example, an event of stopping the display of the present markup image, such as pressing a button for transferring to another markup image. When stop( ) is called, the applet enters a stop state for stopping the display of the applet. If the user revisits the markup image, the applet executing engine 2 calls the start( ) again, so the applet returns to the start state for starting the execution of the applet. Meanwhile, when the applet is discarded from the memory, the applet enters a destroy state for completely discarding the applet.

An example of Java source code for an animation Java applet, which is one of the Java applets included in a markup image and includes the functions SuspendRender( ) and Paint( ) to output the SuspendRender and ResumeRender signals, respectively, as a delay markup image output signal, is as follows.

```
======================================================
public class AnimationApplet extends Applet
  implements Runnable {
  Thread animator;
  Animation animation;
  public void init( ) {
  animator = new Thread(this);
  animation = new RectangleAnimation( );
  animation.init(this);
  }
  public void start( ) {
  if (animator.isAlive( )) {
  animator.resume( );
  } else {
  animator.start( );
  suspendRender( );
  }
  }
  public void stop( ) {
  animator.suspend( );
  }
  public void destroy( ) {
  animator.stop( );
  }
  public void run( ) {
  while (true) {
  repaint( );
  Thread.sleep(500); // sleep for some time
  animation.advance( );
  }
  }
  public void paint (Graphics g) {
  animation.paintFrame(g);
  }
}
======================================================
```

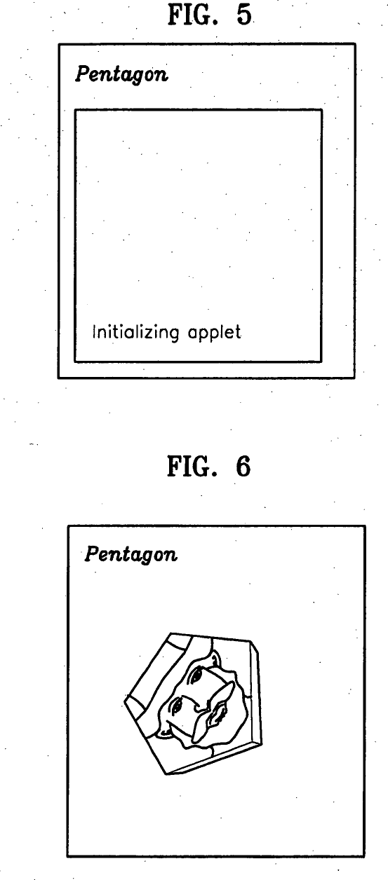

FIG. 5 is an example of a displayed initial markup image linked to an applet, according to a conventional method of displaying a markup document linked to the applet in which a blank applet initial image is displayed and the user is informed that the linked applet is being initialized. In contrast to FIG. 5, according to the present invention, FIG. 6 is an example of a displayed initial markup image linked to an applet, according to an embodiment of the present invention.

As shown in FIG. 6, when the applet is initialized and executed and the initial image of the applet is displayed, the markup document output image is synchronously displayed. Accordingly, the user does not watch a blank applet image and an applet initializing message, which has been displayed while initializing and executing the applet. In other words, since the applet included in or linked to the markup document and the text/image/audio included in the markup document are synchronously executed, the user may conveniently watch/view the markup image linked to the applet. As described above, a markup document linked to an applet according to the present invention is displayed by synchronizing the applet and the markup document outputs so that a blank applet image is not displayed while the applet is initializing and executing. Accordingly, a user may conveniently watch markup image linked to an applet. More particularly, the present invention provides a computer, comprising a programmed computer processor controlling synchronous output of a markup document image and a linked applet image to a display device according to markup image output control information included in the markup document and/or the applet linked to the markup document. In particular, an order of rendering of the markup document image and the linked applet image is controlled by the markup image output control information to synchronously display the markup document image and the linked applet image. Therefore, the decoder 17 selectively buffers audio output from the markup document and the applet output, and selectively buffers image and text output from the markup document and applet output, in response to the markup image output control information, which, for example, can be markup image delay and image output control signals from the applet executing engine and/or markup image delay and image output information provided in the markup document as a tag, to control synchronous display of the markup document image and the linked applet image, such as an initial image of the linked applet.

While this invention has been particularly shown and described with reference to a few example embodiments thereof, it will be understood by those skilled in the art that various changes in form and details may be made therein without departing from the spirit and scope of the invention as defined by the appended claims and their equivalents.

What is claimed is:

1. A method of displaying a markup document linked to an applet, the method comprising:
delaying display of image output information for the markup document; and
synchronously displaying the delayed image output information for the markup document and an applet output when rendering of the applet is completed.

2. The method of claim 1, wherein the delaying of the display of the image output information for the markup document comprises buffering the image output information for the markup document.

3. The method of claim 1, wherein the synchronously displaying the delayed image output information for the markup document and the applet output for an initial image of the applet comprises simultaneously providing the delayed image output information for the markup document and the applet output for the initial image of the applet to a display device based on an output control signal.

4. The method of claim 1, wherein the applet is formed of program codes having an output method different from that of the markup document.

5. The method of claim 3, wherein the output control signal is provided from an applet executing engine, which interprets the applet, or a presentation engine, which interprets the markup document.

6. The method of claim 1, wherein the delaying of the display of the image output information for the markup document comprises buffering text output of the markup document and buffering at least one of an image output and an audio output of the markup document.

7. The method of claim 2, wherein the buffering comprises buffering text output of the markup document and buffering at least one of an image output and an audio output of the markup document.

8. The method of claim 3, wherein the delaying of the display of the image output information for the markup document comprises buffering text output of the markup document and buffering at least one of an image output and an audio output of the markup document.

9. An information storage medium controlling a computer, comprising:
a markup document; and
an applet linked to the markup document,
wherein the applet or the markup document includes markup image output delay information used to delay display of the markup document.

10. The information storage medium of claim 9, wherein the applet executes in any one state of an initial state, a start state, a stop state, and a destroy state.

11. The information storage medium of claim 9, wherein the applet includes a delay function as the markup image output delay information for synchronizing display of image output information of the markup document with display of output information of the applet.

12. The information storage medium of claim 10, wherein the applet includes a delay function during the start state as the markup image output delay information for synchronizing display of image output information of the markup document with display of output information of the applet.

13. The information storage medium of claim 10, wherein the applet comprises:
a delay function as the markup image output delay information, which delays display of image output information for the markup document; and
a delay cancel function canceling the delay of the display of the image output information for the markup document, when rendering of an initial image of the applet is completed by the initial and start states of the applet.

14. The information storage medium of claim 9, wherein the markup document comprises tag or attribute indication information as the markup image output delay information to control synchronous display of output of the markup document with output of the applet.

15. A computer system with a display device, comprising:
a presentation engine, which interprets a markup document to provide image output information for the markup document; and
an applet executing engine, which interprets an applet linked to the markup document to provide an applet output,
wherein the presentation engine delays display of the image output information for the markup document, and synchronizes and outputs the delayed image output information of the markup document and the applet output to the display device, when an output control signal indicating completion of rendering of the applet output is input from the applet executing engine.

16. The system of claim 15, wherein the presentation engine comprises a buffer buffering the image output information of the markup document to delay the display of the image output information for the markup document, in response to a markup image output delay signal input from the applet executing engine.

17. The system of claim 15, wherein the presentation engine comprises an audio buffer, which buffers audio output, and a video buffer, which buffers video output, of the image output information of the markup document and/or of the applet output to delay the display of the image output information for the markup document, in response to the output control signal input from the applet executing engine.

18. The system of claim 16, wherein the markup image output delay signal is set according to an amount of rendering time of the markup document and/or the applet.

19. A computer with a display device, comprising:
a programmed computer processor controlling synchronous output of a markup document image including a linked applet image to the display device, according to display control information in the markup document and/or in the applet.

20. The computer of claim 22, wherein the programmed computer processor controls an order of rendering of the markup document image and the linked applet image according to the display control information to synchronously display the markup document image and the linked applet image.
